(19) United States
(12) Patent Application Publication
(10) Pub. No.: US 2026/0254111 A1
(43) Pub. Date: Aug. 27, 2026

(54) SIDE LOBE MITIGATION VIA ANTENNA ARRAY TRAINING

(71) Applicant: QUALCOMM Incorporated, San Diego, CA (US)

(72) Inventors: Vasanthan RAGHAVAN, West Windsor Township, NJ (US); Yu-Chin OU, San Diego, CA (US); Junyi LI, Greentown, PA (US)

(21) Appl. No.: 19/060,536

(22) Filed: Feb. 21, 2025

(51) Int. Cl. H01Q 3/36; H01Q 1/24

(52) U.S. Cl. CPC H01Q 3/36; H01Q 1/241

(57) ABSTRACT

Side lobe mitigation via antenna array training is described. An apparatus may receive, from a network device and based on a set of training symbols, a first transmission of a first set of beam weights associated with a first subset of randomized antenna elements of the network device. The apparatus may receive, from the network device and based on the set of training symbols, a second transmission of a second set of beam weights associated with a second subset of randomized antenna elements of the network device that is different from the first subset of randomized antenna elements. The apparatus may communicate with the network device based on a side lobe level associated with measurements of the first transmission and the second transmission and via the first subset of randomized antenna elements and the second subset of randomized antenna elements.

### TECHNICAL FIELD

The present disclosure relates generally to communication systems, and more particularly, to wireless communications and side lobe mitigation utilizing antenna array training.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be or may comprise a network entity. The apparatus may receive, from a network device and based on a set of training symbols, a first transmission of a first set of beam weights associated with a first subset of randomized antenna elements of the network device. The apparatus may receive, from the network device and based on the set of training symbols, a second transmission of a second set of beam weights associated with a second subset of randomized antenna elements of the network device that is different from the first subset of randomized antenna elements. The apparatus may communicate with the network device based on a side lobe level associated with measurements of the first transmission and the second transmission and via the first subset of randomized antenna elements and the second subset of randomized antenna elements.

In the aspect, the method may include receiving, from a network device and based on a set of training symbols, a first transmission of a first set of beam weights associated with a first subset of randomized antenna elements of the network device. The method may also include receiving, from the network device and based on the set of training symbols, a second transmission of a second set of beam weights associated with a second subset of randomized antenna elements of the network device that is different from the first subset of randomized antenna elements. The method may also include communicating with the network device based on a side lobe level associated with measurements of the first transmission and the second transmission and via the first subset of randomized antenna elements and the second subset of randomized antenna elements.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating examples of array thinning and side lobe level mitigation, in accordance with various aspects of the present disclosure.

FIG. 5 is a call flow diagram for wireless communications, in accordance with various aspects of the present disclosure.

FIG. 6 is a diagram illustrating examples of measurements of side lobe levels for mitigation, in accordance with various aspects of the present disclosure.

FIG. 7 is a diagram illustrating examples of array training for side lobe level mitigation, in accordance with various aspects of the present disclosure.

FIG. 8 is a diagram illustrating examples of array training for side lobe level mitigation, in accordance with various aspects of the present disclosure.

FIG. 9 is a flowchart of a method of wireless communication.

FIG. 10 is a diagram illustrating an example of a hardware implementation for an example apparatus and/or network entity.

FIG. 11 is a diagram illustrating an example of a hardware implementation for an example network entity.

### DETAILED DESCRIPTION

Wireless communication networks may be designed to support communications between network entities (e.g., network nodes such as base stations, gNBs, etc.) and network devices (e.g., UEs, customer premises equipment (CPEs), radar devices, reflecting/reconfigurable intelligent surfaces (RISs), etc.). For instance, a network entity and a network device in a wireless communication network may communicate in various configurations and using various communication schema to conserve power/energy and to improve capacity in the network. One example communication scheme to conserve network energy utilizes array thinning where antenna elements of transmit (Tx) and receive (Rx) antenna arrays are not fully activated (e.g., are partially activated leaving some elements deactivated). In such configurations, side lobe reduction or mitigation may be sought to achieve these goals. In the context of 5G NR/6G network designs with increased densification, side lobe mitigation may provide for increased network capacity, and in radar designs, when the Tx and Rx arrays are steering energy towards the same direction, mitigating side lobes may provide for the exclusion of spurious signals at the Rx array. Some examples for side lobe mitigation may include amplitude tapering, while other examples may rely on array thinning (e.g., taking a large antenna array and using only a random subset of the available antenna elements).

However, amplitude tapering may lead to Equivalent Isotropic Radiated Power (EIRP) loss as all the antennas are not operated at peak power. In array thinning, as only a subset of antenna elements are used, the EIRP may be reduced relative to peak EIRP conditions, yet, all the active antennas are operating at peak/full power unlike the amplitude tapering scenario. Thus, the EIRP may be pulled back by using a higher-rated power amplifier to make the EIRP similar to/the same as the scenario where all antenna elements are used. Such approaches may adjust the active sets of antenna elements in such a way that the array occupies the full aperture to control main lobe beamwidth, but the side lobe directions may be significantly changed. Side lobes in the Tx and Rx arrays can be significantly different, and selecting different sets of active antenna elements on the Tx and Rx arrays may help mitigate side lobes of radar systems.

Various aspects relate generally to side lobe mitigation utilizing antenna array training. Some aspects more specifically relate to side lobe mitigation via antenna array training antenna (e.g., utilizing array thinning). In some examples, the active sets of antenna elements in the Tx and Rx arrays may be selected to improve network capacity while mitigating side lobe levels to avoid (i) side lobes that are not sufficiently deep and, relatedly, (ii) lower sensitivity than expected. In some situations, given N possible antenna elements over which K are active (e.g., where K<N), there may be ^{N}C_{K} possibilities of active subsets (i.e., a number of possibilities that may be substantially large). Aspects herein provide for greedy and dynamic array training operations to mitigate side lobes via coordination between network devices and network entities in wireless communication networks, such as 5G NR, 6G, and/or the like.

Particular aspects of the subject matter described in this disclosure can be implemented to realize one or more of the following potential advantages. In some examples, by utilizing a greedy, iterative array training for array thinning, the described techniques can be used to more quickly and efficiently determine a reduced subset of randomized antenna elements for Tx and Rx arrays that mitigate side lobe levels.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

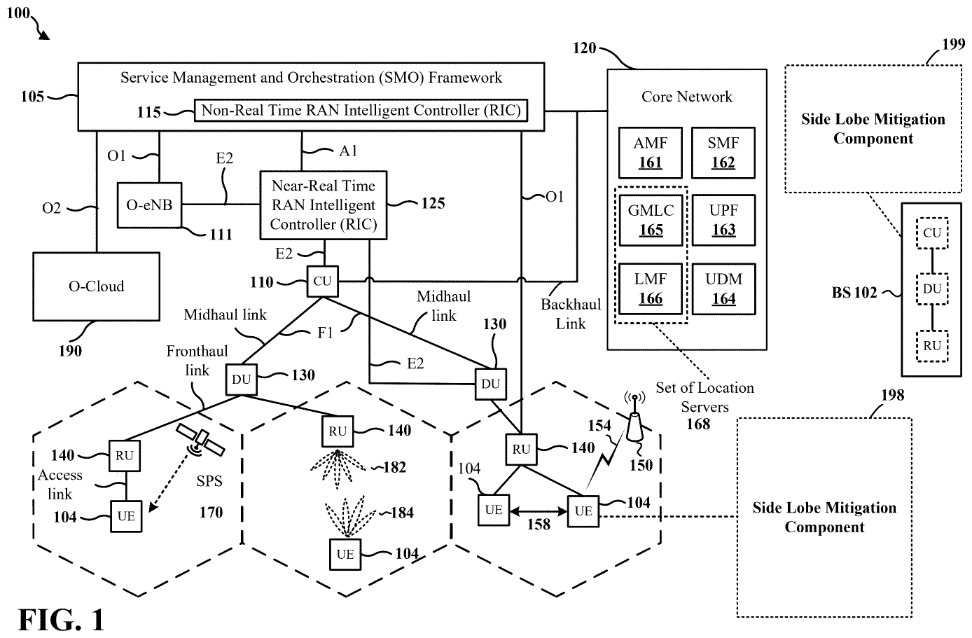

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may have a side lobe mitigation component 199 (“component 199”) that may be configured to receive, from a network device and based on a set of training symbols, a first transmission of a first set of beam weights associated with a first subset of randomized antenna elements of the network device. The component 199 may be configured to receive, from the network device and based on the set of training symbols, a second transmission of a second set of beam weights associated with a second subset of randomized antenna elements of the network device that is different from the first subset of randomized antenna elements. The component 199 may be configured to communicate with the network device based on a side lobe level associated with measurements of the first transmission and the second transmission and via the first subset of randomized antenna elements and the second subset of randomized antenna elements. The component 199 may be configured to receive, from the network device, a request for the set of training symbols, where the request is associated with array training of a transmitter (Tx) array and a receiver (Rx) array at the network device. The component 199 may be configured to receive, from the network device and based on the request, the set of training symbols. The component 199 may be configured to obtain a measurement of a maximum side lobe level associated with the first set of beam weights for the first transmission and the second set of beam weights for the second transmission. The component 199 may be configured to transmit an indication of the measurement of the maximum side lobe level to the network device. The component 199 may be configured to receive, based on the indication of the measurement of the maximum side lobe level, a termination indication indicative of a termination of the array training. The component 199 may be configured to initiate a first training timer at the network entity based on a reception, from the network device, of a request for the set of training symbols. The component 199 may be configured to receive, based on a second expiration of a second training timer at the network device, a termination indication indicative of a termination of the array training. The component 199 may be configured to receive, from the network device and based on the set of training symbols, a set of additional first transmissions of additional first sets of beam weights respectively associated with additional first subsets of randomized antenna elements for the Tx array of the network device. The component 199 may be configured to receive, from the network device and based on the set of training symbols, a set of additional second transmissions of additional second sets of beam weights respectively associated with additional second subsets of randomized antenna elements for the Rx array of the network device that are different from the additional first subsets of randomized antenna elements. The component 199 may be configured to obtain additional measurements of maximum side lobe levels associated with the additional first sets of beam weights for the set of additional first transmissions and the additional second sets of beam weights for the set of additional second transmissions. The component 199 may be configured to transmit additional indications of the additional measurements of the maximum side lobe levels to the network device. In certain aspects, the UE 104 may have a side lobe mitigation component 198 (“component 198”) that may be configured to perform any of the aspects herein for a network device (e.g., a UE). The component 198 may be configured to perform operations in conjunction with the component 199 (e.g., where the component 199 may be configured to receive a transmission, the component 198 may be configured to transmit/provide such a transmission).

Accordingly, aspects provide for the active sets of antenna elements in the Tx and Rx arrays to be efficiently selected to improve network capacity while mitigating side lobe levels, which avoids side lobes that are not sufficiently deep and cause lower sensitivity than expected. Aspects also address the substantially large number of possibilities that may be possible for reduced subsets of randomized antenna elements in Tx/Rx arrays. Aspects herein further provide for greedy and dynamic array training operations to mitigate side lobes via coordination between network devices and network entities in wireless communication networks, such as 5G NR, 6G, and/or the like.

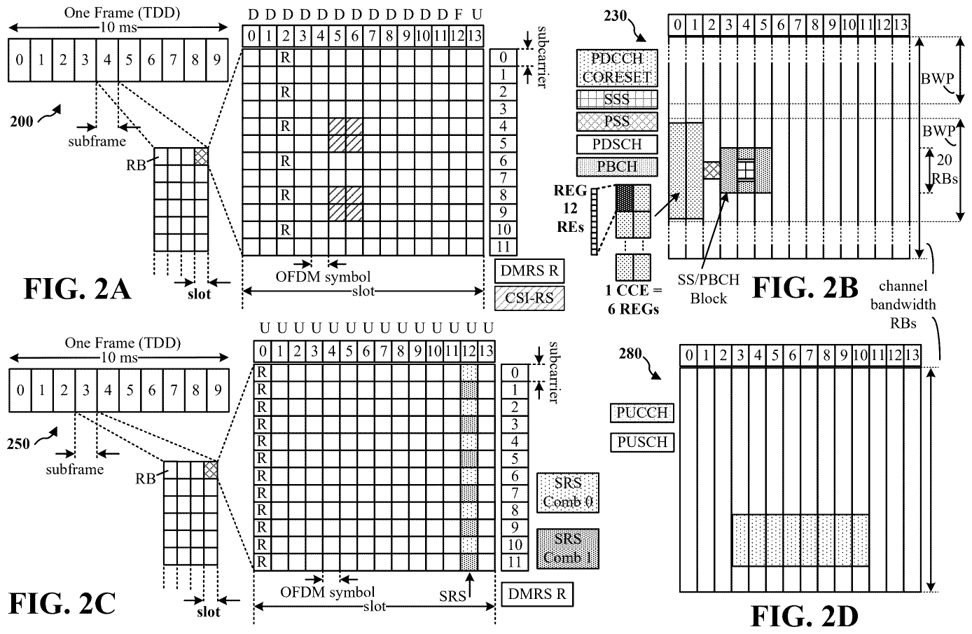

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2ª*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

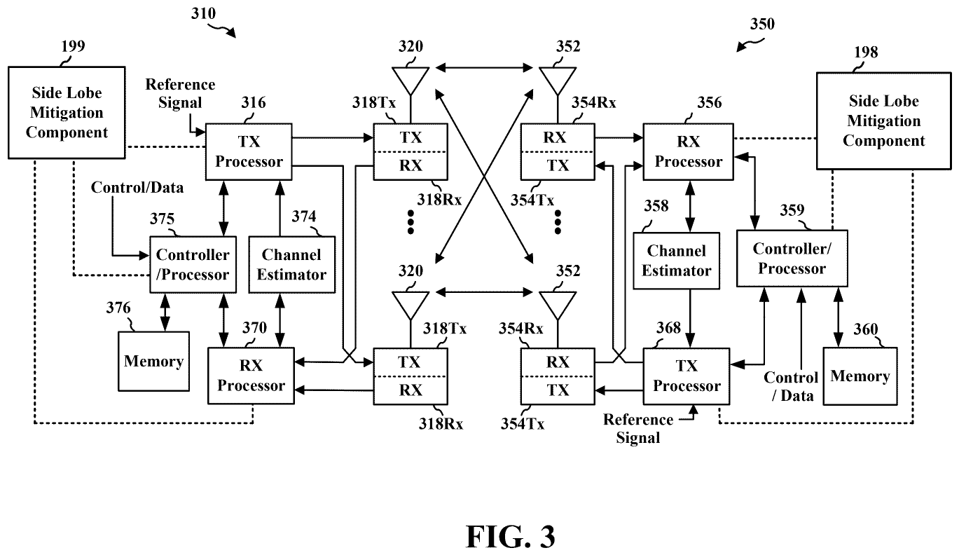

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

One example communication scheme to conserve network energy utilizes array thinning where antenna elements of Tx and Rx antenna arrays are not fully activated (e.g., are partially activated leaving some elements deactivated). In such configurations, side lobe reduction or mitigation may be sought to achieve these goals. In the context of 5G NR/6G network designs with increased densification, side lobe mitigation may provide for increased network capacity, and in radar designs, when the Tx and Rx arrays are steering energy towards the same direction, mitigating side lobes may provide for the exclusion of spurious signals at the Rx array. Some examples for side lobe mitigation may include amplitude tapering, while other examples may rely on array thinning (e.g., taking a large antenna array and using only a random subset of the available antenna elements). However, amplitude tapering may lead to Equivalent Isotropic Radiated Power (EIRP) loss as all the antennas are not operated at peak power. In array thinning, as only a subset of antenna elements are used, the EIRP may be reduced relative to peak EIRP conditions, yet, all the active antennas are operating at peak/full power unlike the amplitude tapering scenario. Thus, EIRP may be pulled back by using a higher-rated power amplifier to make the EIRP similar to/the same as the scenario where all antenna elements are used. Such approaches may adjust the active sets of antenna elements in such a way that the array occupies the full aperture to control main lobe beamwidth, but the side lobe directions may be significantly changed. Side lobes in the Tx and Rx arrays can be significantly different, and selecting different sets of active antenna elements on the Tx and Rx arrays may help mitigate side lobes of radar systems.

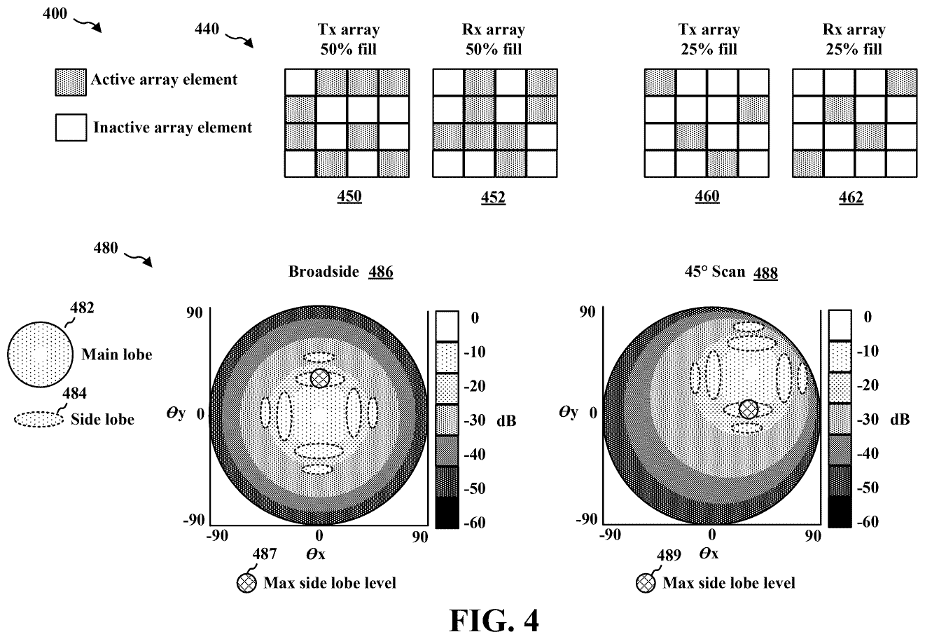

FIG. 4 is a diagram 400 illustrating examples of array thinning and side lobe level mitigation, in various aspects. Diagram 400 shows array thinning configurations 440 and side lobe level mitigation configuration 480.

In the context of array thinning configurations 440, array thinning (e.g., choosing a random subset (e.g., a reduced set) of antenna elements to be active from the given set) may be utilized for mitigating side lobes in Tx-Rx (or radar) operations. As used herein, the term “active antenna element” may mean that the antenna element is turned on or activated for Tx/Rx operations. The set of antenna elements that are active may be represented with {0,1} values to form an active antenna element mask. Example active antenna element masks for a 4×4 antenna element array with 50% filled/active randomized elements (e.g., a Tx array 450 and an Rx array 452) and 25% filled/active randomized elements (e.g., a Tx array 460 and an Rx array 462) are shown. While 4×4 antenna element arrays are shown (e.g., with 16 total antenna elements), aspects also include antenna element arrays of any size (e.g., N×N antenna element arrays, where Nis an integer which may be greater than 1). Similarly, aspects include other percentages of filled/active randomized elements that are less than 100%. The filled/active elements (e.g., based on the active antenna element mask) of a given antenna element array may be selected/determined by a network device (e.g., a UE, a CPE, a radar device, a RIS, etc.).

As noted herein, given N antenna elements, if K active elements are to be selected, there are NCK possibilities. For example, with N=64 and K=32 (e.g., 50% filling of the array), there are 1.8*1018 possibilities, and with N=64 and K=16 (e.g., 25% filling of the array), there are 4.9*1014 possibilities. Such high numbers of possible element combinations to form an array creates high complexity in computation and analysis for the selection of elements. That is, finding the right Tx and Rx active antenna element masks for side lobe mitigation is more complicated as the complexity is squared of the above numbers. Even in the simple case of N=16, with a 50% filling of the array (or 8 active elements), there are 1.7*108 possibilities. In other words, there is no simple solution to determine the correct set of active antenna element masks for side lobe mitigation whether the number of antenna elements is relatively small (e.g., 16) or relatively large (e.g., 64).

In the context of side lobe level mitigation configuration 480, a broadside representation 486 (having a maximum side lobe level 487) and a 45° scan representation 488 (having a maximum side lobe level 489) are shown with respect to directional angles and side lobe levels (e.g., in dB). The broadside representation 486 and the 45° scan representation 488 each include a main lobe 482 located based on respective angles/directions, and also each include side lobe representations 484. In contrasting the broadside representation 486 and the 45° scan representation 488, it may be seen how side lobe locations and levels vary with different angles/directions. Accordingly, selection of active antenna element masks may be implemented to mitigate side lobe levels, yet complexity of determining such active antenna element masks may be prohibitive.

In aspects, an iterative scheme for active antenna element selection to mitigate side lobes (e.g., with array thinning) is provided. Aspects enable system level solutions for array selection to perform array thinning with side lobe mitigation by using a greedy approach to determining the active antenna element mask. Aspects herein provide for the active sets of antenna elements in the Tx and Rx arrays to be efficiently selected to improve network capacity while mitigating side lobe levels, which avoids side lobes that are not sufficiently deep and cause lower sensitivity than expected. Aspects also address the substantially large number of possibilities that may be possible for reduced subsets of randomized antenna elements in Tx/Rx arrays. Aspects herein further provide for greedy and dynamic array training operations to mitigate side lobes via coordination between network devices and network entities in in wireless communication networks, such as 5G NR, 6G, and/or the like. Aspects enable quicker and more efficient determinations of reduced subsets of randomized antenna elements for Tx and Rx arrays that mitigate side lobe levels by utilizing a greedy, iterative array training for array thinning.

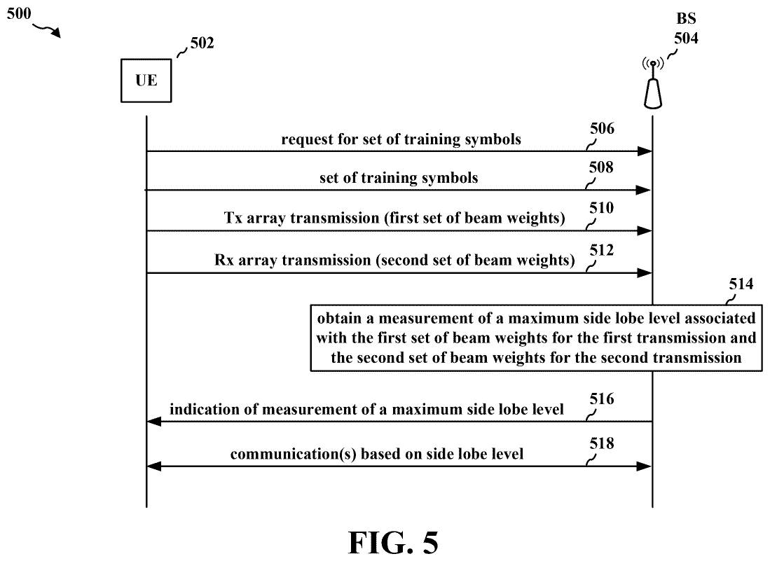

FIG. 5 is a call flow diagram 500 for wireless communications, in various aspects. Call flow diagram 500 illustrates side lobe mitigation via antenna array training (e.g., with array thinning) for a network entity (a base station 504, by way of example) that communicates with a network device (e.g., a UE 502, a customer premises equipment (CPE), a radar device, a reflecting intelligent surface (RIS), and/or the like). In aspects, a network entity may be a network node(s) such as a base station, a gNB, or other type of base station or a DU(s), by way of example, as described herein), in various aspects. Aspects described for the base station 504, and for network entities/nodes herein, generally, may be performed in aggregated form and/or by one or more components in disaggregated form. Additionally, or alternatively, the aspects may be performed by the UE 502 autonomously, in addition to, and/or in lieu of, operations of the base station 504.

The base station 504 (e.g., a network entity) may be configured to receive, and the UE 502 (e.g., a network device) may be configured to provide/transmit, a request 506 for a set of training symbols 508, where the request 506 is associated with array training (e.g., an array training process) of a transmitter (Tx) array and a receiver (Rx) array at the network device/the UE 502. In aspects, the request 506 for the set of training symbols 508 may be indicative of a number of training symbols in the set of training symbols 508. The number of training symbols may be based on at least one of a first number of measurements associated with a determination of a coverage region of the network entity, a second number of iterations for subsets of randomized (e.g., randomly chosen) antenna elements and a performance metric associated with the array training at the network device, and/or the like. The base station 504 (e.g., a network entity) may be configured to receive based on the request 506, and the UE 502 (e.g., a network device) may be configured to provide/transmit, the set of training symbols 508.

In aspects, array thinning may be utilized in antenna array training for side lobe mitigation. A side lobe level may be associated with a reception at an Rx array of a transmission from a Tx array. Aspects provide for a Tx array, e.g., a portion of an antenna array for transmission of wireless signals, to utilize a subset of randomized antenna elements while other array of antenna elements remain inactive. Likewise, an Rx array, e.g., a portion of an antenna array for reception of wireless signals, may utilize another subset of randomized antenna elements while other array of antenna elements remain inactive.

The base station 504 may be configured to receive, from a network device and based on a set of training symbols 508, a first transmission 510 of a first set of beam weights associated with a first subset of randomized antenna elements of the network device. In aspects, the first subset of randomized antenna elements may correspond to a Tx array. The first subset of randomized antenna elements may include a first number of antenna elements that is less than a first total number of available antenna elements for the Tx array. In aspects, the first transmission 510 may be associated with array training of the Tx array and the Rx array at the network device.

The base station 504 may be configured to receive, from the network device and based on the set of training symbols 508, a second transmission 512 of a second set of beam weights associated with a second subset of randomized antenna elements of the network device that is different from the first subset of randomized antenna elements. In aspects, the second subset of randomized antenna elements corresponds to an Rx array. The second subset of randomized antenna elements may include a second number of antenna elements that is less than a second total number of available antenna elements for the Rx array. In aspects, the second transmission 512 may be associated with array training of the Tx array and the Rx array at the network device.

The base station 504 may be configured to obtain (at 514) a measurement of a maximum side lobe level associated with the first set of beam weights for the first transmission 510 and the second set of beam weights for the second transmission 512. The base station 504, to obtain (at 514) the measurement of the maximum side lobe level, may be configured to measure the maximum side lobe level in association with a beam pattern over a set of angles that correspond to the first set of beam weights for the first transmission 510 and the second set of beam weights for the second transmission 512. In aspects, the base station 504 (e.g., the network entity), to measure the maximum side lobe level, may be configured to determine a main lobe gain, determine a gain of a side lobe relative to the main lobe, determine a direction of the side lobe, and/or the like. The base station 504 may be configured to transmit an indication 516 of the measurement of the maximum side lobe level to the UE 502. The base station 504, to obtain (at 514) the measurement of the maximum side lobe level, may be configured to receive, from at least one additional network device or additional network entity, the measurement of the maximum side lobe level in association with a beam pattern over a set of angles that correspond to the first set of beam weights for the first transmission 510 and the second set of beam weights for the second transmission 512. The base station 504 may be configured to receive, based on the indication 516 of the measurement of the maximum side lobe level (e.g., from the UE 502), a termination indication indicative of a termination of the array training. Accordingly, beam patterns may be reciprocal and correspondent independent of whether an antenna array is in the Tx or Rx modes. Thus, for an application where the first antenna array is in Tx mode and the second antenna array is in Rx mode, it is equivalent to having both antenna arrays being in Tx mode and measuring the side lobes with this mode of communications.

In aspects, the base station 504 may be configured to perform iterations of array training. As one example, the base station 504 may be configured to receive, from the UE 502 and based on the set of training symbols 508, a set of additional first transmissions of additional first sets of beam weights respectively associated with additional first subsets of randomized antenna elements for the Tx array of the UE 502 (e.g., the network device). The base station 504 may be configured to receive, from the UE 502 and based on the set of training symbols 508, a set of additional second transmissions of additional second sets of beam weights respectively associated with additional second subsets of randomized antenna elements for the Rx array of the UE 502 (e.g., the network device) that are different from the additional first subsets of randomized antenna elements. The base station 504 may be configured to obtain additional measurements of maximum side lobe levels associated with the additional first sets of beam weights for the set of additional first transmissions and the additional second sets of beam weights for the set of additional second transmissions. The base station 504 may be configured to transmit additional indications of the additional measurements of the maximum side lobe levels to the UE 502 (e.g., the network device).

In aspects, to transmit the additional indications of the additional measurements of the maximum side lobe levels, the base station 504 may be configured to transmit the additional indications of the additional measurements of the maximum side lobe levels prior to receiving the first transmission 510 and the second transmission 512. In aspects, to transmit the additional indications of the additional measurements of the maximum side lobe levels, the base station 504 may be configured to transmit the additional indications of the additional measurements of the maximum side lobe levels prior to receiving the first transmission 510 and the second transmission 512.

In aspects, the base station 504 may be configured to initiate a first training timer at the base station 504 (e.g., the network entity) based on a reception, from the UE 502 (e.g., the network device), of the request 506 for the set of training symbols 508. In aspects, the base station 504 may be configured to receive, based on a second expiration of a second training timer at the UE 502 (e.g., the network device), a termination indication indicative of a termination of the array training.

The base station 504 may be configured to communicate with the network device based on a side lobe level associated with measurements of the first transmission 510 and the second transmission 512 and via the first subset of randomized antenna elements and the second subset of randomized antenna elements. That is, the base station 504 and the UE 502 may be configured to transmit/provide and/or receive a communication(s) 518 between each other. In some aspects, to communicate with the UE 502 (e.g., the network device), the base station 504 (e.g., the network entity) may be configured to communicate with the UE 502 subsequent to receiving the termination indication. In some aspects, to communicate with the UE 502 (e.g., the network device), the base station 504 (e.g., the network entity) may be configured to communicate with the UE 502 subsequent to a first expiration of the first training timer or the termination indication.

In aspects, to communicate with the UE 502 (e.g., the network device), the base station 504 may be configured to communicate with the UE 502 further based on the indication of the measurement of the maximum side lobe level meeting a threshold condition and the additional indications of the additional measurements of the maximum side lobe levels failing to meet the threshold condition. In aspects, to communicate with the UE 502 (e.g., the network device), the base station 504 may be configured to communicate with the UE 502 further based on the indication of the measurement of the maximum side lobe level meeting a threshold condition and an expiration of a training timer.

In aspects, the network entity may be a network node (e.g., a base station, a gNB, a DU, etc.). In aspects, the network device may be at least one of a UE, a CPE, a radar device, a RIS, and/or the like. In aspects, the base station 504 (e.g., the network entity) and/or the network device) may comprise at least one transceiver coupled to at least one processor thereof, and receiving, transmitting/providing, communicating, and/or the like, may be performed via the at least one transceiver.

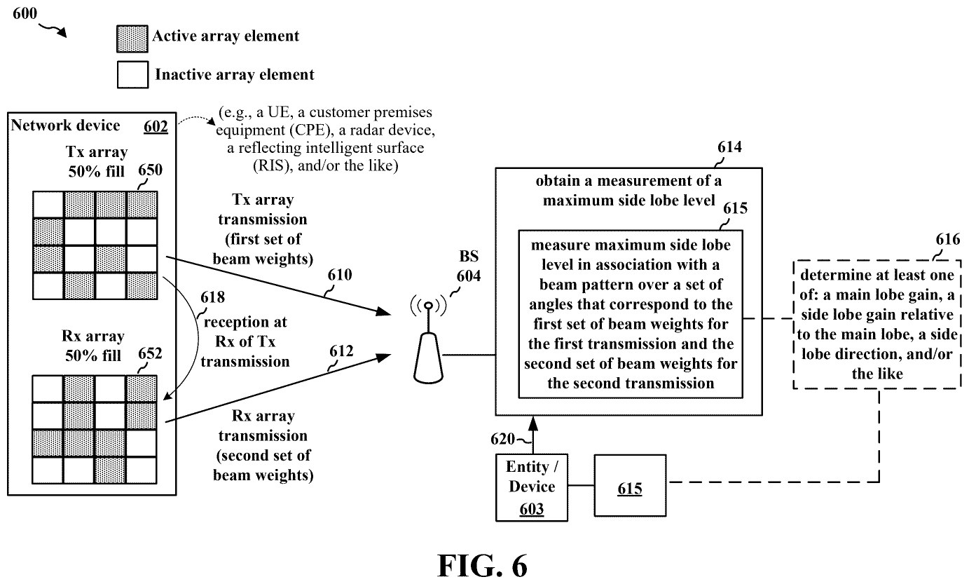

FIG. 6 is a diagram 600 illustrating examples of measurements of side lobe levels for mitigation, in various aspects. Diagram 600 may be an aspect of the call flow diagram 500 in FIG. 5 and is described in the context of a network device 602 and a base station 604 (e.g., also a network entity, generally, such as a network node/gNB), by way of example.

As shown by way of example, the network device 602 may include a Tx array 650 and an Rx array 652, each having 50% fill (although other examples with more or less fill are included or can be considered for aspects herein). The Tx array 650 and the Rx array 652 have subsets of randomized active antenna elements. As used herein, a subset of randomized active antenna elements may be a sparse array or a strict subset with respect to a set of available antenna elements (e.g., the subset includes less than all of the available antenna elements for a given Tx/Rx array). For example, with 16 available antenna elements, using 15 of them at any point in time may still be considered to be a sparse array setup. In aspects, the network device 602 may determine the active antenna element masks (e.g., for the Tx array 650 and the Rx array 652 for the respective subsets of randomized active antenna elements).

In some scenarios, a reception 618 at the Rx array 652 of a transmission from the Tx array 650, and aspects herein for side lobe mitigation via antenna array training address the such receptions as the reception 618. From the Tx array 650 beam pattern and the Rx array 652 beam pattern available at the base station 604, according to aspects, determinations for the side lobe levels (including a maximum side lobe level) when the Tx array 650 transmits to the Rx array 652 for the reception 618 the may be made.

For example, the base station 604 may be configured to receive, from the network device 602 and based on a set of training symbols, a first transmission 610 of a first set of beam weights associated with a first subset of randomized antenna elements of the network device (e.g., the Tx array 650), as similarly described above for FIG. 5. Likewise, the base station 604 may be configured to receive, from the network device 602 and based on the set of training symbols, a second transmission 612 of a second set of beam weights associated with a second subset of randomized antenna elements of the network device (e.g., the Rx array 652) that is different from the first subset of randomized antenna elements (e.g., for the Tx array 650).

The base station 604 may be configured to obtain (at 614) a measurement of a maximum side lobe level associated with the first set of beam weights for the first transmission 610 and the second set of beam weights for the second transmission 612. The base station 604, to obtain (at 614) the measurement of the maximum side lobe level, may be configured to measure (at 615) the maximum side lobe level in association with a beam pattern over a set of angles that correspond to the first set of beam weights for the first transmission 610 and the second set of beam weights for the second transmission 612. In aspects, the base station 604 (e.g., a network entity), to measure (at 615) the maximum side lobe level, may be configured to determine (at 616) at least one of a main lobe gain, a gain of a side lobe relative to the main lobe, a direction of the side lobe, and/or the like. The base station 604 may also be configured to transmit an indication of the measurement of the maximum side lobe level to the network device 602.

In some aspects, the base station 604, to obtain (at 614) the measurement of the maximum side lobe level, may be configured to receive, from at least one additional network device or additional network entity 603, the measurement 620 of the maximum side lobe level in association with a beam pattern over a set of angles that correspond to the first set of beam weights for the first transmission 610 and the second set of beam weights for the second transmission 612. Similarly, a determination (at 616) may be performed by the at least one additional network device or additional network entity 603, and an indication thereof may be provided for the base station 604 (e.g., with the measurement 620).

In other words, over each set of training symbols, the Tx array 650 may transmit (e.g., the first transmission 610) with a set of beam weights with a chosen set of randomized active antenna elements while the network entity (e.g., the base station 604) obtains (at 614)/measures (at 615) to determine beam patterns over different angles (e.g., a main lobe gain, and side lobe gain relative to the main lobe, a side lobe direction(s), etc.). In some aspects, e.g., where the at least one additional network device or additional network entity 603 provides the measurements 620, coordination of measurements 620 across different devices may be performed by the base station 604. Additionally, the Rx array 652 may also transmit (e.g., the second transmission 612) with a set of beam weights with another chosen set of randomized active antenna elements while the base station 604 (and/or other devices/entities 603 in the wireless communication network) measure(s) the side lobe levels to determine the beam pattern(s) over different angles of transmission.

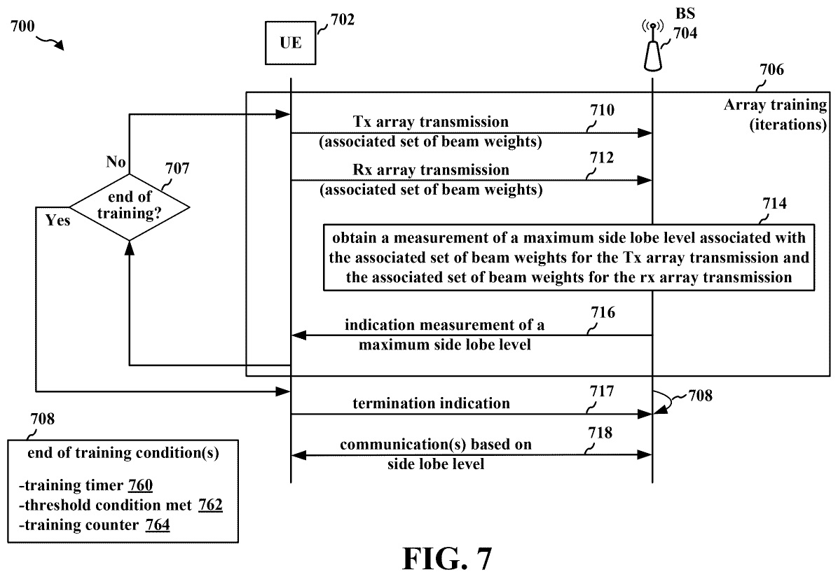

FIG. 7 is a diagram 700 illustrating examples of array training for side lobe level mitigation, in various aspects. Diagram 700 may be an aspect of the call flow diagram 500 in FIG. 5 and/or the diagram 600 in FIG. 6, and is described, by way of example, in the context of array training 706 with iterations over different reduced subsets of randomized antenna elements for a Tx array and an Rx array of a UE 702, for which a base station 704 may obtain measurements of maximum side lobe levels.

Within an iteration of the array training 706, the base station 704 may be configured to receive, from UE 702 (e.g., a network device) and based on a set of training symbols, a first transmission 710 of a first set of beam weights associated with a first subset of randomized antenna elements of the UE 702. Within an iteration of the array training 706, the base station 704 may be configured to receive, from the UE 702 and based on the set of training symbols, a second transmission 712 of a second set of beam weights associated with a second reduced subset of randomized antenna elements of the UE 702 that is different from the first subset of randomized antenna elements. Within an iteration of the array training 706, the base station 704 may be configured to obtain (at 714) a measurement of a maximum side lobe level associated with the first set of beam weights for the first transmission 710 and the second set of beam weights for the second transmission 712. Within an iteration of the array training 706, the base station 704 may be configured to The base station 704 may be configured to transmit an indication 716 of the measurement of the maximum side lobe level to the UE 702.

In aspects, a number of iterations may be performed for a given session of array training 706. In one example, iterations may be performed for a given session of array training 706 until an end of training condition(s) 708 is (are) met. For instance, a training timer 760 expiration, a threshold condition 762 being met for a maximum side lobe level in a current iteration of the array training 706, a training counter 764 reaching a configured value, and/or the like, may be utilized as the end of training condition(s) 708. In some aspects, the end of training condition(s) 708 may be monitored, checked, determined, etc., (at 707) by the UE 702 and/or the base station 704. If the array training 706 is to be continued based on the end of training condition(s) 708, another iteration of the array training 706 may be performed, as described above, for different subsets of randomized antenna elements, and thus different transmissions/associated beam weights, for the Tx array and the Rx array of the UE 702. The array training 706 may be concluded based on the end of training condition(s) 708. In some aspects, if the array training 706 is to be concluded based on the end of training condition(s) 708, the base station 704 may receive, and the UE 702 may transmit/provide, a termination indication 717 indicative of a termination of the array training 706.

Based on the array training 706, which may include iterations of the measurements of side lobe levels for mitigation described above for FIG. 6, a Tx array and an Rx array of respective subsets of randomized antenna elements may be determined and configured for communications 718 (e.g., based on the side lobe levels associated with measurements of the two respective transmissions via the reduced subsets of randomized antenna elements, as described herein).

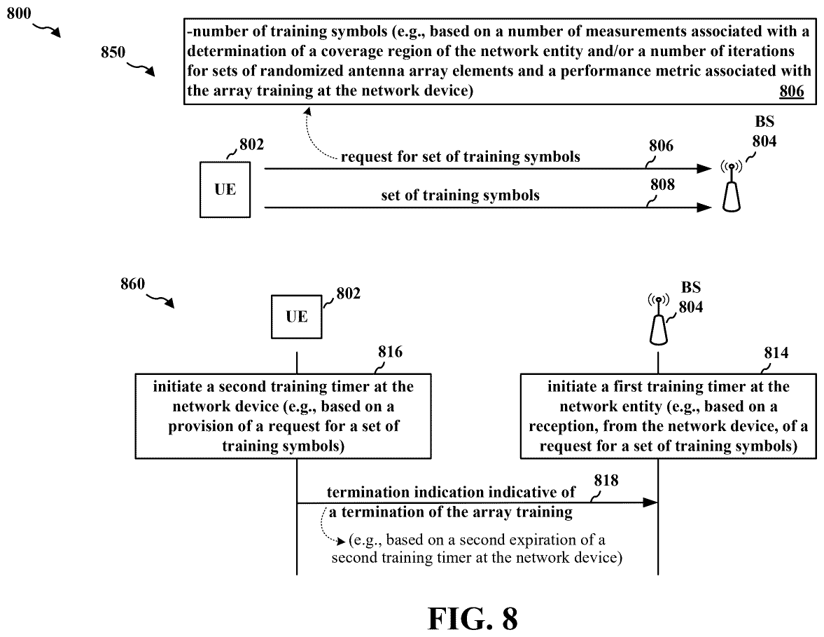

FIG. 8 is a diagram 800 illustrating examples of array training for side lobe level mitigation, in various aspects. Diagram 800 may be an aspect of the call flow diagram 500 in FIG. 5 and is described in the context of a UE 802 and a base station 804, by way of example. In aspects, the UE 802 may include a Tx array and an Rx array, each with a reduced subset of randomized antenna elements, as described herein.

In a configuration 850, the UE 802, with Tx and Rx arrays as noted, may be configured to provide/transmit, and the base station 804 may be configured to receive, a request 806 for a set of training symbols 808 to allow for antenna array training, as described herein. In aspects, the request may be indicative of a number of training symbols in the set of training symbols 808. The number of training symbols requested may be based on a number of measurements associated with a determination of a beam pattern/beam weights for a coverage region (e.g., a sphere or portion thereof) of the network entity (e.g., the base station 804). The number of training symbols requested may be based on a number of iterations for subsets of randomized antenna array elements (e.g., as described for FIG. 7) and a performance metric, such as a maximum side lobe level, associated with the array training. In aspects, more symbols in the set of training symbols 808 may be indicated in the request 806 for better maximum side lobe levels, etc. In aspects, a training period may be stopped once device has reached certain desired performance level (e.g., as a greedy antenna array training) and can be indicated to base station 804.

In a configuration 860, training timers may be utilized as indications to terminate antenna array training. For example, the base station 804 may be configured to initiate (at 814) a first training timer at the base station 804 based on a reception, from the UE 802 (e.g., a network device), of the request 806 for the set of training symbols 808. Additionally or alternatively, the UE 802 may be configured to initiate (at 816) a second training timer at the UE 802 (e.g., based on provision of the request 806 for the set of training symbols 808). In such aspects, the base station 804 may be configured to receive, and the UE 802 may be configured to transmit/provide, a termination indication 818 indicative of a termination of the array training. In aspects, while the first and/or the second training timer is active and not expired, iterations for antenna array training may be performed to determine a best performing active antenna element mask. In some aspects, an iteration counter may be used in addition to or in lieu of a training timer described herein. Accordingly, aspects provide for performance of antenna array training, e.g., with array thinning, in which a time period/counter for the array training may be set to determine active antenna element masks based on side lobe levels over iterations of subsets of randomized antenna elements for Tx and Rx arrays that mitigate side lobe levels.

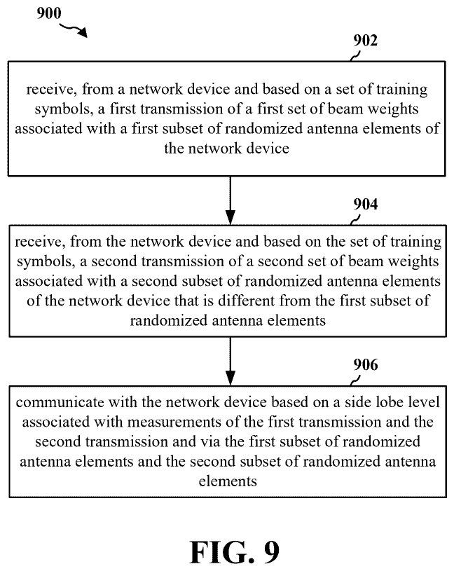

FIG. 9 is a flowchart 900 of a method of wireless communication. The method may be performed by a network entity or a network node (e.g., the base station 102, 504, 604, 704; the network entity 1002, 1102). The method may be for side lobe mitigation via antenna array training (e.g., with array thinning). The method may enable quicker and more efficient determinations of reduced subsets of randomized antenna elements for Tx and Rx arrays that mitigate side lobe levels by utilizing a greedy, iterative array training for array thinning.

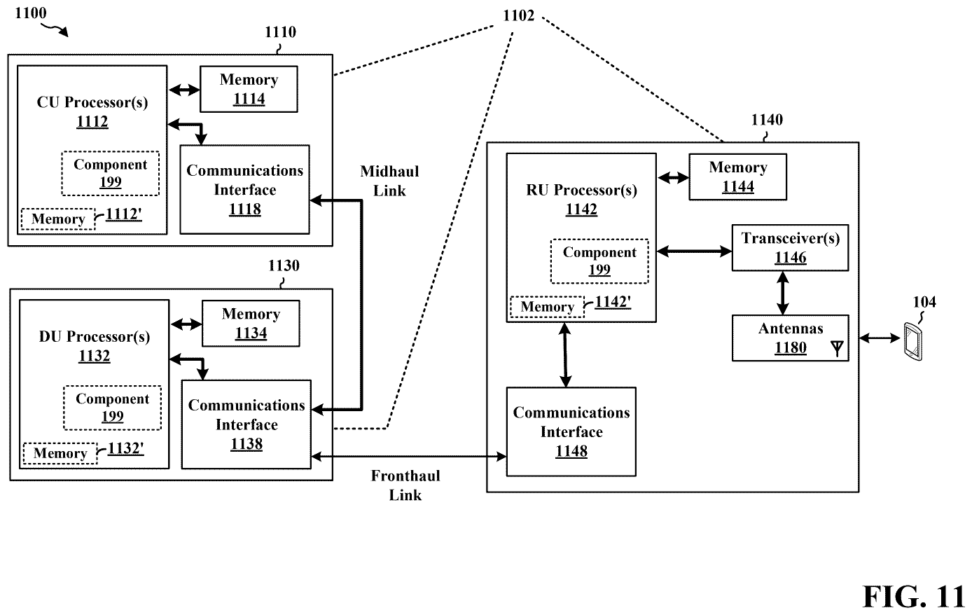

At 902, the network entity receives, from a network device and based on a set of training symbols, a first transmission of a first set of beam weights associated with a first subset of randomized antenna elements of the network device. As an example, the reception may be performed by one or more of the component 199, the transceiver(s) 1146, and/or the antenna 1180 in FIG. 11. FIG. 5 illustrates an example of a network entity (e.g., the base station 504) receiving such a first transmission from a network device (e.g., the UE 502).

The base station 504 (e.g., a network entity) may be configured to receive, and the UE 502 (e.g., a network device) may be configured to provide/transmit, a request 506 (e.g., 806 in FIG. 8) for a set of training symbols 508 (e.g., 808 in FIG. 8), where the request 506 (e.g., 806 in FIG. 8) is associated with array training of a transmitter (Tx) array (e.g., 650 in FIG. 6) and a receiver (Rx) array (e.g., 652 in FIG. 6) at the network device/the UE 502. In aspects, the request 506 (e.g., 806 in FIG. 8) for the set of training symbols 508 (e.g., 808 in FIG. 8) may be indicative of a number of training symbols in the set of training symbols 508 (e.g., 808 in FIG. 8). The number of training symbols may be based on at least one of a first number of measurements associated with a determination of a coverage region of the network entity, a second number of iterations for subsets of randomized antenna elements and a performance metric associated with the array training at the network device, and/or the like. The base station 504 (e.g., a network entity) may be configured to receive based on the request 506 (e.g., 806 in FIG. 8), and the UE 502 (e.g., a network device) may be configured to provide/transmit, the set of training symbols 508 (e.g., 808 in FIG. 8).

In aspects, array thinning may be utilized in antenna array training (e.g., 706 in FIG. 7) for side lobe mitigation. A side lobe level may be associated with a reception (e.g., 618 in FIG. 6) at an Rx array (e.g., 652 in FIG. 6) of a transmission from a Tx array (e.g., 650 in FIG. 6). Aspects provide for a Tx array (e.g., 650 in FIG. 6), e.g., a portion of an antenna array for transmission of wireless signals, to utilize a subset of randomized antenna elements while other array of antenna elements remain inactive. Likewise, an Rx array (e.g., 652 in FIG. 6), e.g., a portion of an antenna array for reception of wireless signals, may utilize another subset of randomized antenna elements while other array of antenna elements remain inactive.

The base station 504 may be configured to receive, from a network device and based on a set of training symbols 508 (e.g., 808 in FIG. 8), a first transmission 510 (e.g., 610 in FIG. 6; 710 in FIG. 7) of a first set of beam weights associated with a first subset of randomized antenna elements of the network device. In aspects, the first subset of randomized antenna elements may correspond to a Tx array (e.g., 650 in FIG. 6). The first subset of randomized antenna elements may include a first number of antenna elements that is less than a first total number of available antenna elements for the Tx array (e.g., 650 in FIG. 6). In aspects, the first transmission 510 (e.g., 610 in FIG. 6; 710 in FIG. 7) may be associated with array training (e.g., 706 in FIG. 7) of the Tx array (e.g., 650 in FIG. 6) and the Rx array (e.g., 652 in FIG. 6) at the network device.

At 904, the network entity receives, from the network device and based on the set of training symbols, a second transmission of a second set of beam weights associated with a second subset of randomized antenna elements of the network device that is different from the first subset of randomized antenna elements. As an example, the reception may be performed by one or more of the component 199, the transceiver(s) 1146, and/or the antenna 1180 in FIG. 11. FIG. 5 illustrates an example of a network entity (e.g., the base station 504) receiving such a first transmission from a network device (e.g., the UE 502).

The base station 504 may be configured to receive, from the network device and based on the set of training symbols 508 (e.g., 808 in FIG. 8), a second transmission 512 (e.g., 612 in FIG. 6; 712 in FIG. 7) of a second set of beam weights associated with a second subset of randomized antenna elements of the network device that is different from the first subset of randomized antenna elements. In aspects, the second subset of randomized antenna elements corresponds to an Rx array (e.g., 652 in FIG. 6). The second subset of randomized antenna elements may include a second number of antenna elements that is less than a second total number of available antenna elements for the Rx array (e.g., 652 in FIG. 6). In aspects, the second transmission 512 (e.g., 612 in FIG. 6; 712 in FIG. 7) may be associated with array training (e.g., 706 in FIG. 7) of the Tx array (e.g., 650 in FIG. 6) and the Rx array (e.g., 652 in FIG. 6) at the network device.

The base station 504 may be configured to obtain (at 514) (e.g., 614 in FIG. 6; 714 in FIG. 7) a measurement (e.g., 620 in FIG. 6) of a maximum side lobe level associated with the first set of beam weights for the first transmission 510 (e.g., 610 in FIG. 6; 710 in FIG. 7) and the second set of beam weights for the second transmission 512 (e.g., 612 in FIG. 6; 712 in FIG. 7). The base station 504, to obtain (at 514) (e.g., 614 in FIG. 6; 714 in FIG. 7) the measurement (e.g., 620 in FIG. 6) of the maximum side lobe level, may be configured to measure the maximum side lobe level in association with a beam pattern over a set of angles that correspond to the first set of beam weights for the first transmission 510 (e.g., 610 in FIG. 6; 710 in FIG. 7) and the second set of beam weights for the second transmission 512 (e.g., 612 in FIG. 6; 712 in FIG. 7). In aspects, the base station 504 (e.g., the network entity), to measure (e.g., 615 in FIG. 6) the maximum side lobe level, may be configured to determine (e.g., at 616 in FIG. 6) a main lobe gain, determine a gain of a side lobe relative to the main lobe, determine a direction of the side lobe, and/or the like. The base station 504 may be configured to transmit an indication 516 (e.g., 716 in FIG. 7) of the measurement (e.g., 620 in FIG. 6) of the maximum side lobe level to the UE 502. The base station 504, to obtain (at 514) (e.g., 614 in FIG. 6; 714 in FIG. 7) the measurement (e.g., 620 in FIG. 6) of the maximum side lobe level, may be configured to receive, from at least one additional network device or additional network entity (e.g., 603 in FIG. 6), the measurement (e.g., 620 in FIG. 6) of the maximum side lobe level in association with a beam pattern over a set of angles that correspond to the first set of beam weights for the first transmission 510 (e.g., 610 in FIG. 6; 710 in FIG. 7) and the second set of beam weights for the second transmission 512 (e.g., 612 in FIG. 6; 712 in FIG. 7). The base station 504 may be configured to receive, based on the indication 516 (e.g., 716 in FIG. 7) of the measurement (e.g., 620 in FIG. 6) of the maximum side lobe level (e.g., from the UE 502), a termination indication (e.g., 717 in FIG. 7; 818 in FIG. 8) indicative of a termination (e.g., 707 in FIG. 7) of the array training (e.g., 706 in FIG. 7).

In aspects, the base station 504 may be configured to perform iterations of array training (e.g., 706 in FIG. 7). As one example, the base station 504 may be configured to receive, from the UE 502 and based on the set of training symbols 508 (e.g., 808 in FIG. 8), a set of additional first transmissions (e.g., 710 of 706 in FIG. 7) of additional first sets of beam weights respectively associated with additional first subsets of randomized antenna elements for the Tx array (e.g., 650 in FIG. 6) of the UE 502 (e.g., the network device). The base station 504 may be configured to receive, from the UE 502 and based on the set of training symbols 508 (e.g., 808 in FIG. 8), a set of additional second transmissions (e.g., 712 of 706 in FIG. 7) of additional second sets of beam weights respectively associated with additional second subsets of randomized antenna elements for the Rx array (e.g., 652 in FIG. 6) of the UE 502 (e.g., the network device) that are different from the additional first subsets of randomized antenna elements. The base station 504 may be configured to obtain (e.g., 714 of 706 in FIG. 6) additional measurements of maximum side lobe levels associated with the additional first sets of beam weights for the set of additional first transmissions (e.g., 710 of 706 in FIG. 7) and the additional second sets of beam weights for the set of additional second transmissions (e.g., 712 of 706 in FIG. 7). The base station 504 may be configured to transmit additional indications (e.g., 716 of 706 in FIG. 7) of the additional measurements of the maximum side lobe levels to the UE 502 (e.g., the network device).

In aspects, to transmit the additional indications (e.g., 716 of 706 in FIG. 7) of the additional measurements of the maximum side lobe levels, the base station 504 may be configured to transmit the additional indications (e.g., 716 of 706 in FIG. 7) of the additional measurements of the maximum side lobe levels prior to receiving the first transmission 510 (e.g., 610 in FIG. 6; 710 in FIG. 7) and the second transmission 512 (e.g., 612 in FIG. 6; 712 in FIG. 7). In aspects, to transmit the additional indications (e.g., 716 of 706 in FIG. 7) of the additional measurements of the maximum side lobe levels, the base station 504 may be configured to transmit the additional indications (e.g., 716 of 706 in FIG. 7) of the additional measurements of the maximum side lobe levels prior to receiving the first transmission 510 (e.g., 610 in FIG. 6; 710 in FIG. 7) and the second transmission 512 (e.g., 612 in FIG. 6; 712 in FIG. 7).

In aspects, the base station 504 may be configured to initiate (e.g., at 814 in FIG. 8) a first training timer (e.g., 760 in FIG. 7) at the base station 504 (e.g., the network entity) based on a reception, from the UE 502 (e.g., the network device), of the request 506 (e.g., 806 in FIG. 8) for the set of training symbols 508 (e.g., 808 in FIG. 8). In aspects, the base station 504 may be configured to receive, based on a second expiration of a second training timer (e.g., 760 in FIG. 7) at the UE 502 (e.g., the network device), a termination indication (e.g., 717 in FIG. 7; 818 in FIG. 8) indicative of a termination (e.g., 707 in FIG. 7) of the array training (e.g., 706 in FIG. 7).

At 906, the network entity communicates with the network device based on a side lobe level associated with measurements of the first transmission and the second transmission and via the first subset of randomized antenna elements and the second subset of randomized antenna elements. As an example, the communication may be performed by one or more of the component 199, the transceiver(s) 1146, and/or the antenna 1180 in FIG. 11. FIG. 5 illustrates an example of a network entity (e.g., the base station 504) communicating based on such a side lobe level with a network device (e.g., the UE 502).

The base station 504 may be configured to communicate (e.g., 718 in FIG. 7) with the network device based on a side lobe level associated with measurements of the first transmission 510 (e.g., 610 in FIG. 6; 710 in FIG. 7) and the second transmission 512 (e.g., 612 in FIG. 6; 712 in FIG. 7) and via the first subset of randomized antenna elements and the second subset of randomized antenna elements. That is, the base station 504 and the UE 502 may be configured to transmit/provide and/or receive a communication(s) 518 (e.g., 718 in FIG. 7) between each other. In some aspects, to communicate with the UE 502 (e.g., the network device), the base station 504 (e.g., the network entity) may be configured to communicate with the UE 502 subsequent to receiving the termination indication. In some aspects, to communicate with the UE 502 (e.g., the network device), the base station 504 (e.g., the network entity) may be configured to communicate with the UE 502 subsequent to a first expiration of the first training timer (e.g., 760 in FIG. 7) or the termination indication.

In aspects, to communicate with the UE 502 (e.g., the network device), the base station 504 may be configured to communicate with the UE 502 further based on the indication of the measurement of the maximum side lobe level meeting a threshold condition (e.g., 762 in FIG. 7) and the additional indications (e.g., 716 of 706 in FIG. 7) of the additional measurements of the maximum side lobe levels failing to meet the threshold condition (e.g., 762 in FIG. 7). In aspects, to communicate with the UE 502 (e.g., the network device), the base station 504 may be configured to communicate with the UE 502 further based on the indication of the measurement of the maximum side lobe level meeting a threshold condition (e.g., 762 in FIG. 7) and an expiration of a training timer (e.g., 760 in FIG. 7).

In aspects, the network entity may be a network node (e.g., a base station, a gNB, a DU, etc.). In aspects, the network device may be at least one of a UE, a CPE, a radar device, a RIS, and/or the like. In aspects, the base station 504 (e.g., the network entity) and/or the network device) may comprise at least one transceiver coupled to at least one processor thereof, and receiving, transmitting/providing, communicating, and/or the like, may be performed via the at least one transceiver.

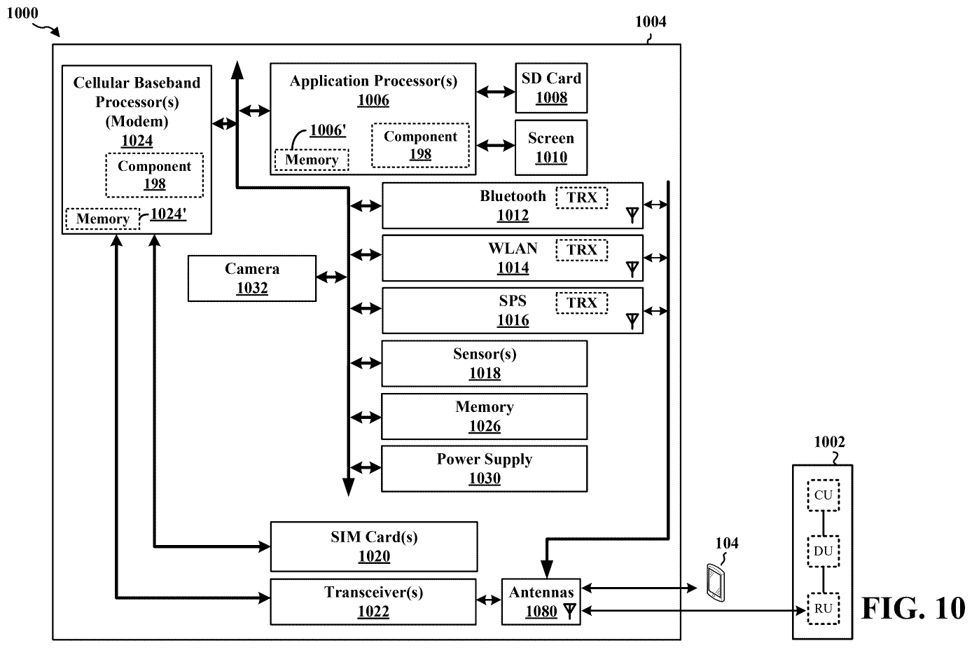

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The cellular baseband processor(s) 1024 and the application processor(s) 1006 are configured to perform the various functions described supra based at least in part of the information stored in the memory. That is, the cellular baseband processor(s) 1024 and the application processor(s) 1006 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the component 198 may be configured to perform any of the aspects herein for a network device (e.g., a UE). The component 198 may be configured to perform operations in conjunction with the component 199 (e.g., where the component 199 may be configured to receive a transmission, the component 198 may be configured to transmit/provide such a transmission). The component 198 may be further configured to perform any of the aspects described in connection with the flowchart in FIG. 9, and/or any of the aspects performed by a network entity/network node for any of FIGS. 4-8. The component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for performing any of the aspects herein for a network device (e.g., a UE). In one configuration, the apparatus 1004, and in particular the cellular baseband processor(s) 1024 and/or the application processor(s) 1006, may include means for performing operations in conjunction with the component 199 (e.g., where the component 199 may be configured to receive a transmission, In one configuration, the apparatus 1004, and in particular the cellular baseband processor(s) 1024 and/or the application processor(s) 1006, may include means for transmitting/providing such a transmission). The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a network device and based on a set of training symbols, a first transmission of a first set of beam weights associated with a first subset of randomized antenna elements of the network device. The component 199 may be configured to receive, from the network device and based on the set of training symbols, a second transmission of a second set of beam weights associated with a second subset of randomized antenna elements of the network device that is different from the first subset of randomized antenna elements. The component 199 may be configured to communicate with the network device based on a side lobe level associated with measurements of the first transmission and the second transmission and via the first subset of randomized antenna elements and the second subset of randomized antenna elements. The component 199 may be configured to receive, from the network device, a request for the set of training symbols, where the request is associated with array training of a Tx array and an Rx array at the network device. The component 199 may be configured to receive, from the network device and based on the request, the set of training symbols. The component 199 may be configured to obtain a measurement of a maximum side lobe level associated with the first set of beam weights for the first transmission and the second set of beam weights for the second transmission. The component 199 may be configured to transmit an indication of the measurement of the maximum side lobe level to the network device. The component 199 may be configured to receive, based on the indication of the measurement of the maximum side lobe level, a termination indication indicative of a termination of the array training. The component 199 may be configured to initiate a first training timer at the network entity based on a reception, from the network device, of a request for the set of training symbols. The component 199 may be configured to receive, based on a second expiration of a second training timer at the network device, a termination indication indicative of a termination of the array training. The component 199 may be configured to receive, from the network device and based on the set of training symbols, a set of additional first transmissions of additional first sets of beam weights respectively associated with additional first subsets of randomized antenna elements for the Tx array of the network device. The component 199 may be configured to receive, from the network device and based on the set of training symbols, a set of additional second transmissions of additional second sets of beam weights respectively associated with additional second subsets of randomized antenna elements for the Rx array of the network device that are different from the additional first subsets of randomized antenna elements. The component 199 may be configured to obtain additional measurements of maximum side lobe levels associated with the additional first sets of beam weights for the set of additional first transmissions and the additional second sets of beam weights for the set of additional second transmissions. The component 199 may be configured to transmit additional indications of the additional measurements of the maximum side lobe levels to the network device. The component 199 may be further configured to perform any of the aspects described in connection with the flowchart in FIG. 9, and/or any of the aspects performed by a network entity/network node for any of FIGS. 4-8. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 may include means for receiving, from a network device and based on a set of training symbols, a first transmission of a first set of beam weights associated with a first subset of randomized antenna elements of the network device. In one configuration, the network entity 1102 may include means for receiving, from the network device and based on the set of training symbols, a second transmission of a second set of beam weights associated with a second subset of randomized antenna elements of the network device that is different from the first subset of randomized antenna elements. In one configuration, the network entity 1102 may include means for communicating with the network device based on a side lobe level associated with measurements of the first transmission and the second transmission and via the first subset of randomized antenna elements and the second subset of randomized antenna elements. In one configuration, the network entity 1102 may include means for receiving, from the network device, a request for the set of training symbols, where the request is associated with array training of a Tx array and an Rx array at the network device. In one configuration, the network entity 1102 may include means for receiving, from the network device and based on the request, the set of training symbols. In one configuration, the network entity 1102 may include means for obtaining a measurement of a maximum side lobe level associated with the first set of beam weights for the first transmission and the second set of beam weights for the second transmission. In one configuration, the network entity 1102 may include means for transmitting an indication of the measurement of the maximum side lobe level to the network device. In one configuration, the network entity 1102 may include means for receiving, based on the indication of the measurement of the maximum side lobe level, a termination indication indicative of a termination of the array training. In one configuration, the network entity 1102 may include means for initiating a first training timer at the network entity based on a reception, from the network device, of a request for the set of training symbols. In one configuration, the network entity 1102 may include means for receiving, based on a second expiration of a second training timer at the network device, a termination indication indicative of a termination of the array training. In one configuration, the network entity 1102 may include means for receiving, from the network device and based on the set of training symbols, a set of additional first transmissions of additional first sets of beam weights respectively associated with additional first subsets of randomized antenna elements for the Tx array of the network device. In one configuration, the network entity 1102 may include means for receiving, from the network device and based on the set of training symbols, a set of additional second transmissions of additional second sets of beam weights respectively associated with additional second subsets of randomized antenna elements for the Rx array of the network device that are different from the additional first subsets of randomized antenna elements. In one configuration, the network entity 1102 may include means for obtaining additional measurements of maximum side lobe levels associated with the additional first sets of beam weights for the set of additional first transmissions and the additional second sets of beam weights for the set of additional second transmissions. In one configuration, the network entity 1102 may include means for transmitting additional indications of the additional measurements of the maximum side lobe levels to the network device. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

A network entity and a network device in a wireless communication network may communicate in various configurations and using various communication schema to conserve power/energy and to improve capacity in the network. One example communication scheme to conserve network energy utilizes array thinning where antenna elements of Tx and Rx antenna arrays are not fully activated (e.g., are partially activate leaving some elements deactivated). In such configurations, side lobe reduction or mitigation may be sought to achieve these goals. In the context of 5G NR/6G network designs with increased densification, side lobe mitigation may provide for increased network capacity, and in radar designs, when the Tx and Rx arrays are steering energy towards the same direction, mitigating side lobes may provide for the exclusion of spurious signals at the Rx array. Some examples for side lobe mitigation may include amplitude tapering, while other examples may rely on array thinning (e.g., taking a large antenna array and using only a random subset of the available antenna elements). However, amplitude tapering may lead to EIRP loss as all the antennas are not operated at peak power. In array thinning, as only a subset of antenna elements are used, the EIRP may be reduced relative to peak EIRP conditions, yet, all the active antennas are operating at peak/full power unlike the amplitude tapering scenario. Thus, EIRP may be pulled back by using a higher-rated power amplifier to make the EIRP similar to/the same as the scenario where all antenna elements are used. Such approaches may adjust the active sets of antenna elements in such a way that the array occupies the full aperture to control main lobe beam width, but the side lobe directions may be significantly changed. Side lobes in the Tx and Rx arrays can be significantly different, and selecting different sets of active antenna elements on the Tx and Rx arrays may help mitigate side lobes of radar systems.

Aspects herein provide for the active sets of antenna elements in the Tx and Rx arrays to be efficiently selected to improve network capacity while mitigating side lobe levels, which avoids side lobes that are not sufficiently deep and cause lower sensitivity than expected. Aspects also address the substantially large number of possibilities that may be possible for reduced subsets of randomized antenna elements in Tx/Rx arrays. Aspects herein further provide for greedy and dynamic array training operations to mitigate side lobes via coordination between network devices and network entities in in wireless communication networks, such as 5G NR, 6G, and/or the like. Aspects enable quicker and more efficient determinations of reduced subsets of randomized antenna elements for Tx and Rx arrays that mitigate side lobe levels by utilizing a greedy, iterative array training for array thinning.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network entity, comprising: receiving, from a network device and based on a set of training symbols, a first transmission of a first set of beam weights associated with a first set of randomized antenna elements of the network device; receiving, from the network device and based on the set of training symbols, a second transmission of a second set of beam weights associated with a second set of randomized antenna elements of the network device that is different from the first set of randomized antenna elements; and communicating with the network device based on a side lobe level associated with measurements of the first transmission and the second transmission and via the first set of randomized antenna elements and the second set of randomized antenna elements.

Aspect 2 is the method of aspect 1, wherein the first set of randomized antenna elements corresponds to a transmitter (Tx) array and the second set of randomized antenna elements corresponds to a receiver (Rx) array.

Aspect 3 is the method of aspect 2, wherein the first set of randomized antenna elements includes a first number of antenna elements that is less than a first total number of available array of antenna elements for the Tx array, wherein the second set of randomized antenna elements includes a second number of antenna elements that is less than a second total number of available array of antenna elements for the Rx array.

Aspect 4 is the method of aspect 2, wherein the side lobe level is associated with a reception at the Rx array of a transmission from the Tx array.

Aspect 5 is the method of any of aspects 1 to 4, further comprising: receiving, from the network device, a request for the set of training symbols, wherein the request is associated with array training of a transmitter (Tx) array and a receiver (Rx) array at the network device; and receiving, from the network device and based on the request, the set of training symbols.

Aspect 6 is the method of aspect 5, wherein the request for the set of training symbols is indicative of a number of training symbols in the set of training symbols, wherein the number of training symbols is based on at least one of: a first number of measurements associated with a determination of a coverage region of the network entity; or a second number of iterations for subsets of randomized antenna elements and a performance metric associated with the array training at the network device.

Aspect 7 is the method of any of aspects 1 to 6, further comprising: obtaining a measurement of a maximum side lobe level associated with the first set of beam weights for the first transmission and the second set of beam weights for the second transmission; and transmitting an indication of the measurement of the maximum side lobe level to the network device.

Aspect 8 is the method of aspect 7, wherein the first transmission and the second transmission are associated with array training of a transmitter (Tx) array and a receiver (Rx) array at the network device; wherein the method further comprises: receiving, based on the indication of the measurement of the maximum side lobe level, a termination indication indicative of a termination of the array training; wherein communicating with the network device includes communicating with the network device subsequent to receiving the termination indication.

Aspect 9 is the method of aspect 7, wherein the first transmission and the second transmission are associated with array training at the network device; wherein the method further comprises: initiating a first training timer at the network entity based on a reception, from the network device, of a request for the set of training symbols, or receiving, based on a second expiration of a second training timer at the network device, a termination indication indicative of a termination of the array training; wherein communicating with the network device includes communicating with the network device subsequent to a first expiration of the first training timer or the termination indication.

Aspect 10 is the method of aspect 7, further comprising: receiving, from the network device and based on the set of training symbols, a set of additional first transmissions of additional first sets of beam weights respectively associated with additional first subsets of randomized antenna elements for a transmitter (Tx) array and a receiver (Rx) array of the network device; receiving, from the network device and based on the set of training symbols, a set of additional second transmissions of additional second sets of beam weights respectively associated with additional second subsets of randomized antenna elements for the Rx array of the network device that are different from the additional first subsets of randomized antenna elements; obtaining additional measurements of maximum side lobe levels associated with the additional first sets of beam weights for the set of additional first transmissions and the additional second sets of beam weights for the set of additional second transmissions; and transmitting additional indications of the additional measurements of the maximum side lobe levels to the network device.

Aspect 11 is the method of aspect 10, wherein transmitting the additional indications of the additional measurements of the maximum side lobe levels includes transmitting the additional indications of the additional measurements of the maximum side lobe levels prior to receiving the first transmission and the second transmission; wherein communicating with the network device includes communicating with the network device further based on the indication of the measurement of the maximum side lobe level meeting a threshold condition and the additional indications of the additional measurements of the maximum side lobe levels failing to meet the threshold condition.

Aspect 12 is the method of aspect 10, wherein transmitting the additional indications of the additional measurements of the maximum side lobe levels includes transmitting the additional indications of the additional measurements of the maximum side lobe levels prior to receiving the first transmission and the second transmission; wherein communicating with the network device includes communicating with the network device further based on the indication of the measurement of the maximum side lobe level meeting a threshold condition and an expiration of a training timer.

Aspect 13 is the method of aspect 7, wherein obtaining the measurement of the maximum side lobe level includes measuring the maximum side lobe level in association with a beam pattern over a set of angles that correspond to the first set of beam weights for the first transmission and the second set of beam weights for the second transmission.

Aspect 14 is the method of aspect 13, wherein measuring the maximum side lobe level includes at least one of: determining a main lobe gain, determining a gain of a side lobe relative to a main lobe, or determining a direction of the side lobe.

Aspect 15 is the method of aspect 7, wherein obtaining the measurement of the maximum side lobe level includes receiving, from at least one additional network device or additional network entity, the measurement of the maximum side lobe level in association with a beam pattern over a set of angles that correspond to the first set of beam weights for the first transmission and the second set of beam weights for the second transmission.

Aspect 16 is the method of any of aspects 1 to 15, wherein the network entity is a network node and the network device is at least one of a user equipment (UE), a customer premises equipment (CPE), a radar device, or a reflecting intelligent surface (RIS).

Aspect 17 is an apparatus for wireless communication at a network entity, comprising: at least one memory; and at least one processor coupled to the at least one memory, the at least one processor is configured to perform the method of any of aspects 1 to 16.

Aspect 18 is an apparatus for wireless communication at a network entity, comprising means for performing each step in the method of any of aspects 1 to 16.

Aspect 19 is the apparatus of any of aspects 17 to 18, further comprising a transceiver configured to receive or to transmit in association with the method of any of aspects 1 to 16.

Aspect 20 is a computer-readable medium storing computer executable code at a network entity, the code when executed by at least one processor causes the at least one processor to perform the method of any of aspects 1 to 16.

What is claimed is:

1. An apparatus for wireless communication at a network entity, comprising:
at least one memory; and
at least one processor coupled to the at least one memory and, based at least in part on information stored in the at least one memory, the at least one processor is configured to:
receive, from a network device and based on a set of training symbols, a first transmission of a first set of beam weights associated with a first subset of randomized antenna elements of the network device;
receive, from the network device and based on the set of training symbols, a second transmission of a second set of beam weights associated with a second subset of randomized antenna elements of the network device that is different from the first subset of randomized antenna elements; and
communicate with the network device based on a side lobe level associated with measurements of the first transmission and the second transmission and via the first subset of randomized antenna elements and the second subset of randomized antenna elements.

2. The apparatus of claim 1, wherein the first subset of randomized antenna elements corresponds to a transmitter (Tx) array and the second subset of randomized antenna elements corresponds to a receiver (Rx) array.

3. The apparatus of claim 2, wherein the first set of randomized antenna elements includes a first number of antenna elements that is less than a first total number of available array of antenna elements for the Tx array, wherein the second set of randomized antenna elements includes a second number of antenna elements that is less than a second total number of available array of antenna elements for the Rx array.

4. The apparatus of claim 2, wherein the side lobe level is associated with a reception at the Rx array of a transmission from the Tx array.

5. The apparatus of claim 1, wherein the at least one processor is further configured to:
receive, from the network device, a request for the set of training symbols, wherein the request is associated with array training of a transmitter (Tx) array and a receiver (Rx) array at the network device; and
receive, from the network device and based on the request, the set of training symbols.

6. The apparatus of claim 5, wherein the request for the set of training symbols is indicative of a number of training symbols in the set of training symbols, wherein the number of training symbols is based on at least one of:
a first number of measurements associated with a determination of a coverage region of the network entity; or
a second number of iterations for subsets of randomized antenna elements and a performance metric associated with the array training at the network device.

7. The apparatus of claim 1, wherein the at least one processor is further configured to:
obtain a measurement of a maximum side lobe level associated with the first set of beam weights for the first transmission and the second set of beam weights for the second transmission; and
transmit an indication of the measurement of the maximum side lobe level to the network device.

8. The apparatus of claim 7, wherein the first transmission and the second transmission are associated with array training of a transmitter (Tx) array and a receiver (Rx) array at the network device;
wherein the at least one processor is further configured to:
receive, based on the indication of the measurement of the maximum side lobe level, a termination indication indicative of a termination of the array training;
wherein to communicate with the network device, the at least one processor is configured to communicate with the network device subsequent to receiving the termination indication.

9. The apparatus of claim 7, wherein the first transmission and the second transmission are associated with array training of a transmitter (Tx) array and a receiver (Rx) array at the network device;
wherein the at least one processor is further configured to:
initiate a first training timer at the network entity based on a reception, from the network device, of a request for the set of training symbols, or
receive, based on a second expiration of a second training timer at the network device, a termination indication indicative of a termination of the array training;
wherein to communicate with the network device, the at least one processor is configured to communicate with the network device subsequent to a first expiration of the first training timer or the termination indication.

10. The apparatus of claim 7, wherein the at least one processor is further configured to:
receive, from the network device and based on the set of training symbols, a set of additional first transmissions of additional first sets of beam weights respectively associated with additional first subsets of randomized antenna elements for of a transmitter (Tx) array of the network device;
receive, from the network device and based on the set of training symbols, a set of additional second transmissions of additional second sets of beam weights respectively associated with additional second subsets of randomized antenna elements for a receiver (Rx) array of the network device that are different from the additional first subsets of randomized antenna elements;
obtain additional measurements of maximum side lobe levels associated with the additional first sets of beam weights for the set of additional first transmissions and the additional second sets of beam weights for the set of additional second transmissions; and
transmit additional indications of the additional measurements of the maximum side lobe levels to the network device.

11. The apparatus of claim 10, wherein to transmit the additional indications of the additional measurements of the maximum side lobe levels, the at least one processor is configured to transmit the additional indications of the additional measurements of the maximum side lobe levels prior to receiving the first transmission and the second transmission;
wherein to communicate with the network device, the at least one processor is configured to communicate with the network device further based on the indication of the measurement of the maximum side lobe level meeting a threshold condition and the additional indications of the additional measurements of the maximum side lobe levels failing to meet the threshold condition.

12. The apparatus of claim 10, wherein to transmit the additional indications of the additional measurements of the maximum side lobe levels, the at least one processor is configured to transmit the additional indications of the additional measurements of the maximum side lobe levels prior to receiving the first transmission and the second transmission;
wherein to communicate with the network device, the at least one processor is configured to communicate with the network device further based on the indication of the measurement of the maximum side lobe level meeting a threshold condition and an expiration of a training timer.

13. The apparatus of claim 7, wherein to obtain the measurement of the maximum side lobe level, the at least one processor is configured to measure the maximum side lobe level in association with a beam pattern over a set of angles that correspond to the first set of beam weights for the first transmission and the second set of beam weights for the second transmission.

14. The apparatus of claim 13, wherein to measure the maximum side lobe level, the at least one processor is configured to at least one of:
determine a main lobe gain,
determine a gain of a side lobe relative to a main lobe, or
determine a direction of the side lobe.

15. The apparatus of claim 7, wherein to obtain the measurement of the maximum side lobe level, the at least one processor is configured to receive, from at least one additional network device or additional network entity, the measurement of the maximum side lobe level in association with a beam pattern over a set of angles that correspond to the first set of beam weights for the first transmission and the second set of beam weights for the second transmission.

16. The apparatus of claim 1, wherein the network entity is a network node and the network device is at least one of a user equipment (UE), a customer premises equipment (CPE), a radar device, or a reflecting intelligent surface (RIS).

17. The apparatus of claim 1, further comprising at least one transceiver coupled to the at least one processor;
wherein the at least one processor, to communicate with the network device, is configured to communicate with the network device via the at least one transceiver.

18. A method of wireless communication at a network entity, comprising:
receiving, from a network device and based on a set of training symbols, a first transmission of a first set of beam weights associated with a first subset of randomized antenna elements of the network device;
receiving, from the network device and based on the set of training symbols, a second transmission of a second set of beam weights associated with a second subset of randomized antenna elements of the network device that is different from the first subset of randomized antenna elements; and
communicating with the network device based on a side lobe level associated with measurements of the first transmission and the second transmission and via the first subset of randomized antenna elements and the second subset of randomized antenna elements.

19. The method of claim 18, wherein the first subset of randomized antenna elements corresponds to a transmitter (Tx) array and the second subset of randomized antenna elements corresponds to a receiver (Rx) array;
wherein the side lobe level is associated with a reception at the Rx array of a transmission from the Tx array.

20. A computer-readable medium storing computer executable code at a network entity, the code when executed by at least one processor causes the at least one processor to:
receive, from a network device and based on a set of training symbols, a first transmission of a first set of beam weights associated with a first subset of randomized antenna elements of the network device;
receive, from the network device and based on the set of training symbols, a second transmission of a second set of beam weights associated with a second subset of randomized antenna elements of the network device that is different from the first subset of randomized antenna elements; and
communicate with the network device based on a side lobe level associated with measurements of the first transmission and the second transmission and via the first subset of randomized antenna elements and the second subset of randomized antenna elements.
